(19) United States
(12) Patent Application Publication
(10) Pub. No.: US 2025/0028137 A1
(43) Pub. Date: Jan. 23, 2025

(54) ACTUATOR AND OPTICAL UNIT

(71) Applicant: NIDEC INSTRUMENTS CORPORATION, Nagano (JP)

(72) Inventors: Shogo KASAHARA, Nagano (JP); Takeshi SUE, Nagano (JP)

(21) Appl. No.: 18/777,545

(22) Filed: Jul. 19, 2024

(30) Foreign Application Priority Data
Jul. 20, 2023 (JP) 2023-118328

(51) Int. Cl. G02B 7/00; G02B 7/02

(52) U.S. Cl. CPC G02B 7/005; G02B 7/02; G03B 2205/0069

(57) ABSTRACT

An actuator capable of connecting with a lens unit and a sensor unit including a movable body, a fixed body holding the movable body in a turnable state, a gimbal mechanism having a turnable member and support parts which support the turnable member in a turnable state, and a drive mechanism having magnets, coils and a flexible board connecting the coils for turning the movable body with respect to the fixed body. The turnable member has a base plate in a frame shape into which the movable body is inserted, and a plurality of leg parts extended from the base plate along the optical axis direction, and the support parts are engaged with the leg parts and support the leg parts in a turnable state. The support part of the gimbal mechanism is provided at two positions in the fixed body and at two positions in the movable body.

### CROSS REFERENCE TO RELATED APPLICATION

The present invention claims priority under 35 U.S.C. § 119 to Japanese Application No. 2023-118328 filed Jul. 20, 2023, the entire content of which is incorporated herein by reference.

### TECHNICAL FIELD

At least an embodiment of the present invention may relate to an actuator and an optical unit.

### BACKGROUND

Conventionally, various optical units have been used. Among these optical units, an optical unit has been known which includes a lens unit, a sensor unit and an actuator capable of connecting with the lens unit and the sensor unit. For example, in Japanese Patent Laid-Open No. 2017-21332 (Patent Literature 1), an optical unit is disclosed which includes a movable body having an imaging module provided with a lens and an imaging element, and a fixed body which holds the movable body in a turnable state with a direction intersecting an optical axis direction as a turning axis.

A conventional optical unit including a lens unit, a sensor unit and an actuator capable of connecting with the lens unit and the sensor unit is often provided with a gimbal mechanism and a drive mechanism having magnets, coils and a flexible board connecting the coils with each other. In this case, in a structure that support parts which support leg parts of the gimbal mechanism are formed in a fixed body and a movable body, when the flexible board is disposed at a position in the vicinity of the support part formed in the movable body, the support part formed in the movable body is located in the vicinity of an end part of the movable body when the movable body is turned with respect to the fixed body and thus, the flexible board and the movable body may be easily interfered with each other. In order to prevent interference between the flexible board and the movable body, when a distance between the vicinity of the support part of the movable body and the flexible board is increased, wall thickness of the fixed body where the flexible board is disposed becomes thin and thus, the rigidity is easily reduced. On the other hand, in order to increase rigidity of the portion of the fixed body where the flexible board is disposed, when a reinforcing part is formed in the vicinity of the portion of the fixed body, a size of the actuator may be easily increased and, as a result, the optical unit is easily enlarged.

### SUMMARY

According to at least an embodiment of the present invention, there may be provided an actuator which is capable of connecting with a lens unit and a sensor unit. The actuator includes a movable body which is connected with the lens unit and the sensor unit and has a first face and a second face, which face each other and are parallel to an optical axis direction, and a third face and a fourth face which face each other and are parallel to the optical axis direction and perpendicular to the first face and the second face, a fixed body which holds the movable body in a turnable state with at least one of intersecting directions intersecting the optical axis direction as a turning axis, a gimbal mechanism which includes a turnable member which has a base plate in a frame shape into which the movable body is inserted, and a plurality of leg parts which are extended from the base plate along the optical axis direction, and support parts which are engaged with the leg parts and support the leg parts in a turnable state, and a drive mechanism which has magnets, coils and a flexible board connecting the coils with each other and generates a drive force for turning the movable body with respect to the fixed body. The drive mechanism includes, as the magnets, a first magnet disposed on the first face, a second magnet disposed on the second face, a third magnet disposed on the third face, and a fourth magnet disposed on the fourth face and, as the coils, a first coil disposed on a face facing the first magnet of the fixed body, a second coil disposed on a face facing the second magnet of the fixed body, a third coil disposed on a face facing the third magnet of the fixed body, and a fourth coil disposed on a face facing the fourth magnet of the fixed body and, as the flexible board, a first flexible board connecting the first coil with the third coil, a second flexible board connecting the third coil with the second coil, and a third flexible board connecting the second coil with the fourth coil. The support part of the gimbal mechanism is provided at two positions in the fixed body on an extension line of a first straight line which is extended from a position between the first face and the third face to a position between the second face and the fourth face when viewed in the optical axis direction, and at two positions in the movable body on an extension line of a second straight line which is extended from a position between the first face and the fourth face to a position between the second face and the third face when viewed in the optical axis direction.

### Effects of the Invention

According to the embodiment of the present invention, a size of the actuator which is capable of connecting with the lens unit and the sensor unit can be reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an optical unit in accordance with an embodiment of the present invention.

FIG. 2 is an exploded perspective view showing a lens unit, a sensor unit and an actuator of the optical unit shown in FIG. 1.

FIG. 3 is a front view showing the actuator of the optical unit in FIG. 1.

FIG. 4 is a front view showing a movable body of the actuator of the optical unit in FIG. 1.

FIG. 5 is a front view showing a fixed body of the actuator of the optical unit in FIG. 1.

FIG. 6 is a perspective view showing the movable body and a gimbal mechanism of the actuator in the optical unit shown in FIG. 1.

FIG. 7 is a cross-sectional view showing the movable body and the gimbal mechanism of the actuator in the optical unit shown in FIG. 1 which is cut in the “A-A” line in FIG. 3.

FIG. 8 is a cross-sectional view showing the fixed body, the movable body and the gimbal mechanism of the actuator in the optical unit shown in FIG. 1 which is cut in the “B-B” line in FIG. 3.

FIG. 9 is a cross-sectional view showing the actuator of the optical unit in FIG. 1 which is viewed from a front face side.

FIG. 10 is a perspective view showing coils and a flexible board of the actuator in the optical unit shown in FIG. 1.

FIG. 11 is a side view showing the actuator of the optical unit in FIG. 1.

### DETAILED DESCRIPTION

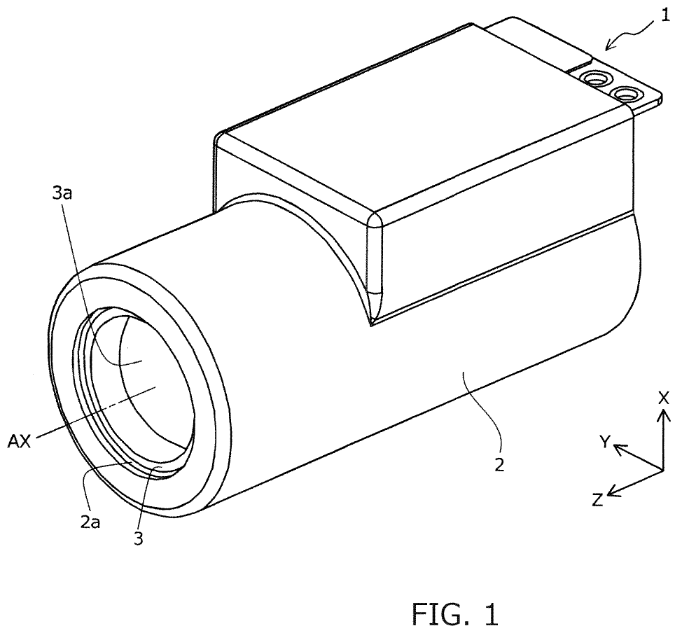

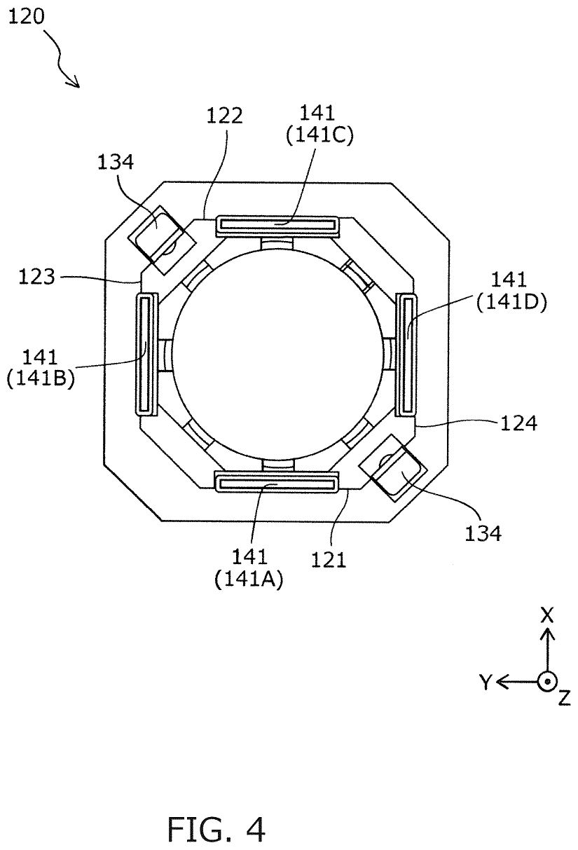

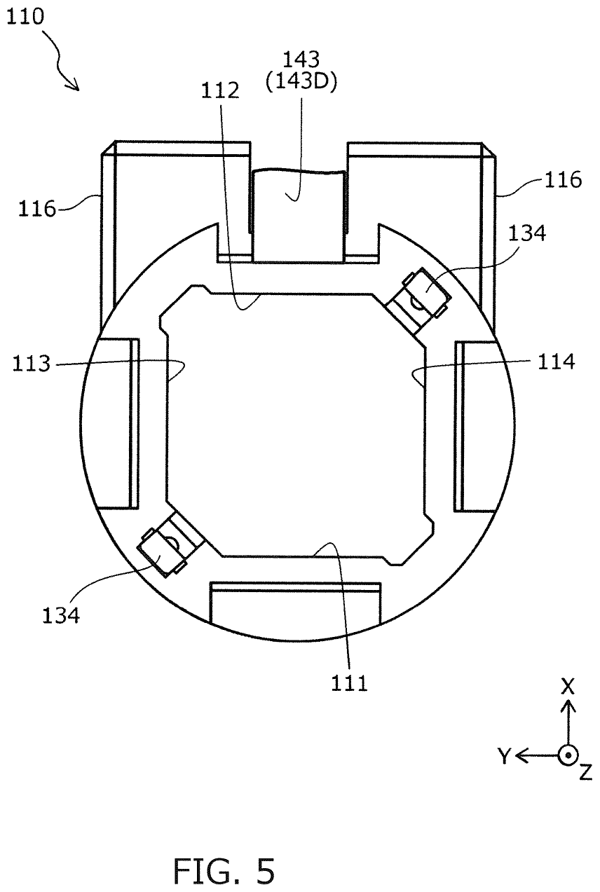

An optical unit 1 in accordance with an embodiment of the present invention will be described below with reference to FIGS. 1 through 11. In each figure, a “Z”-axis direction is an optical axis direction extending in an optical axis “AX”, an “X”-axis direction is a direction intersecting the optical axis “AX”, i.e., an axial direction of yawing, and a “Y”-axis direction is a direction intersecting the optical axis “AX”, i.e., an axial direction of pitching. Further, in the “Z”-axis direction, a “+Z” direction which is a direction where the arrow is directed is an object side direction, and a “−Z” direction which is a reverse direction to the direction where the arrow is directed is an anti-object side direction which is an opposite side to the object side.

### <Entire Structure of Optical Unit>

First, an entire structure of an optical unit 1 in accordance with an embodiment of the present invention will be described below. The optical unit 1 in this embodiment includes a housing 2 as shown in FIG. 1. As shown in FIG. 1, the housing 2 is provided with a lens unit 3 having a lens 3a.

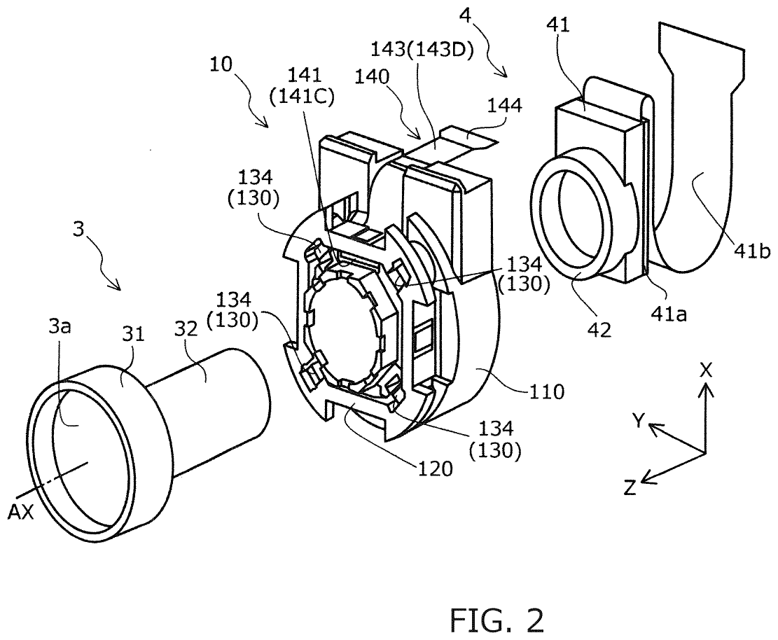

Further, the housing 2 is, as shown in FIG. 2, provided with an actuator 10 and a sensor unit 4 in addition to the lens unit 3. As shown in FIG. 1, the housing 2 is provided with a hole part 2a and, when viewed in the optical axis direction, the lens unit 3 is arranged in the housing 2 so that the lens 3a is viewed through the hole part 2a. The actuator 10 is structured so as to connect with the lens unit 3 and the sensor unit 4 and is capable of displacing the lens unit 3 in the housing 2.

### <Lens Unit>

The lens unit 3 in this embodiment is connected with the actuator 10 and, in addition, connected with the sensor unit 4 in a state connected with the actuator 10. As shown in FIG. 2, the lens unit 3 in this embodiment is provided with a lens attaching portion 31 to which the lens 3a is attached, and a first connecting portion 32 whose diameter is smaller than the lens attaching portion 31. The first connecting portion 32 is connected with the actuator 10 and is also connected with the sensor unit 4.

### <Sensor Unit>

The sensor unit 4 in this embodiment includes a large rectangular portion 41 having an imaging element 41a and a second connecting portion 42 with which the first connecting portion 32 is connected. In this embodiment, the first connecting portion 32 is formed in a cylindrical tubular shape, and the second connecting portion 42 is also formed in a cylindrical tubular shape. Further, in a state that the first connecting portion 32 is connected with the actuator 10, the first connecting portion 32 and the second connecting portion 42 are connected with each other so that an outer peripheral part of the first connecting portion 32 is fitted to an inner peripheral part of the second connecting portion 42. The imaging element 41a is connected with a flexible board 41b.

### <Actuator>

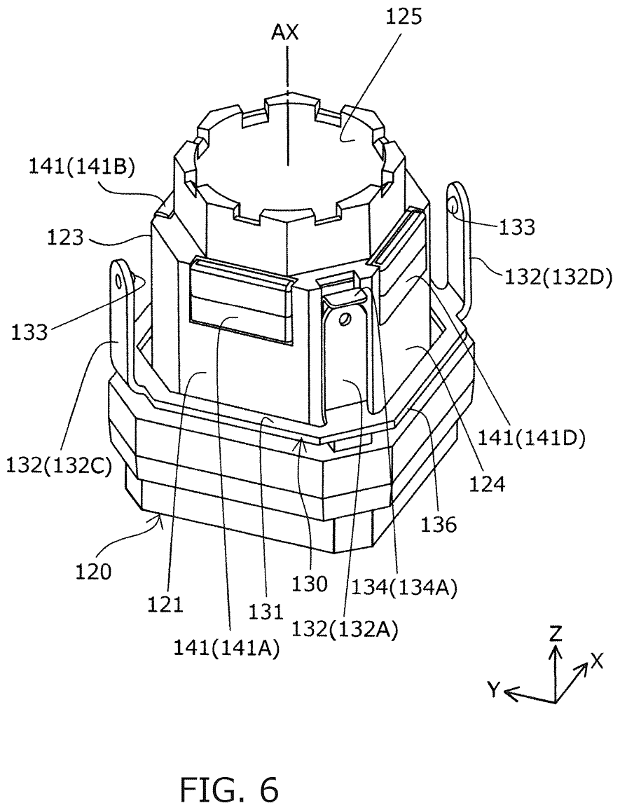

As shown in FIG. 2 and the like, the actuator 10 in this embodiment includes a fixed body 110 which is fixed to the housing 2, and a movable body 120 which is connected with the lens unit 3 and the sensor unit 4 and is displaceable with respect to the fixed body 110. Further, the actuator 10 in this embodiment includes a gimbal mechanism 130 which is connected with the fixed body 110 and the movable body 120 as shown in FIGS. 6 through 8 and the like.

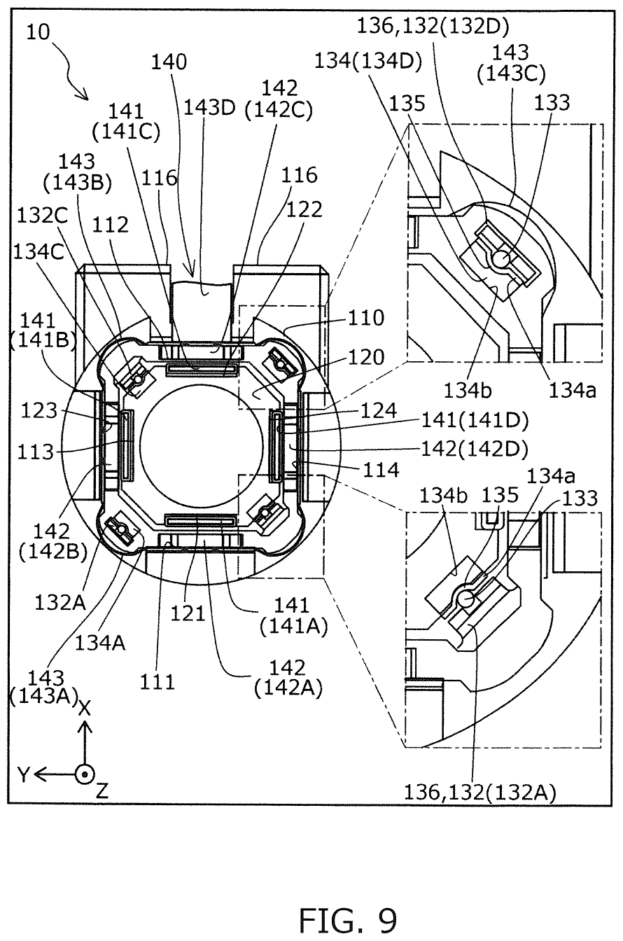

The fixed body 110 holds the movable body 120 by the gimbal mechanism 130 in a turnable state with at least one of intersecting directions intersecting the optical axis direction such as the “X”-axis direction and the “Y”-axis direction as a turning axis. In addition, the actuator 10 in this embodiment includes, as shown in FIG. 9 and the like, a drive mechanism 140 which is provided with magnets 141, coils 142 and a flexible board 143 and is structured to generate a drive force for turning the movable body 120 with respect to the fixed body 110. In this embodiment, the flexible board 143 is provided with a flexible board 143A, a flexible board 143B and a flexible board 143C each of which connects the coils 142 with each other, and a flexible board 143D connected with a terminal 144 as shown in FIG. 2.

### <Movable Body>

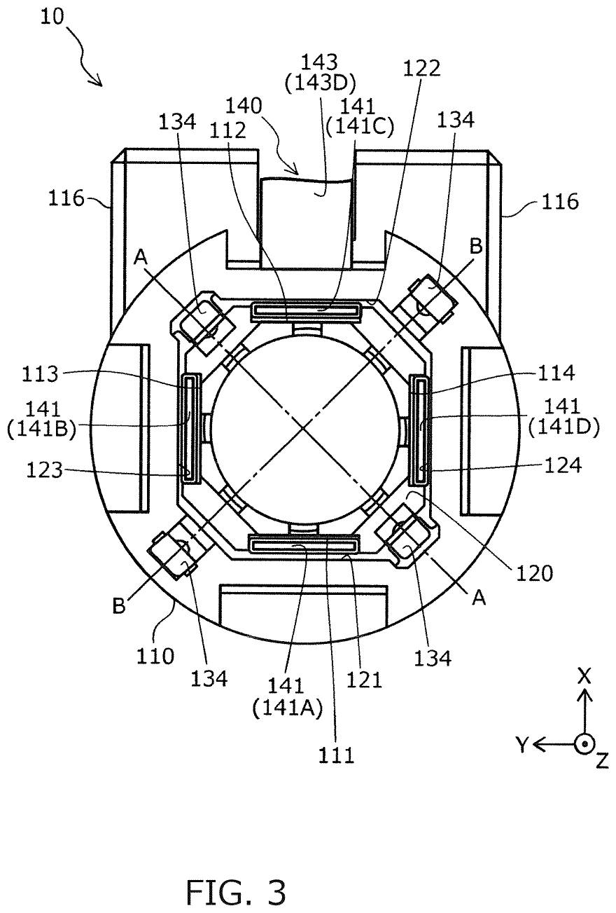

The movable body 120 is, as shown in FIGS. 3, 4, 6 and 9, provided with a first face 121 and a second face 122, which are parallel with an optical axis direction (“Z”-axis direction) and face each other, and a third face 123 and a fourth face 124 which are parallel with the optical axis direction and perpendicular to the first face 121 and the second face 122 and face each other. The first face 121 is provided with a magnet 141A as the magnet 141, the second face 122 is provided with a magnet 141C as the magnet 141, the third face 123 is provided with a magnet 141B as the magnet 141, and the fourth face 124 is provided with a magnet 141D as the magnet 141.

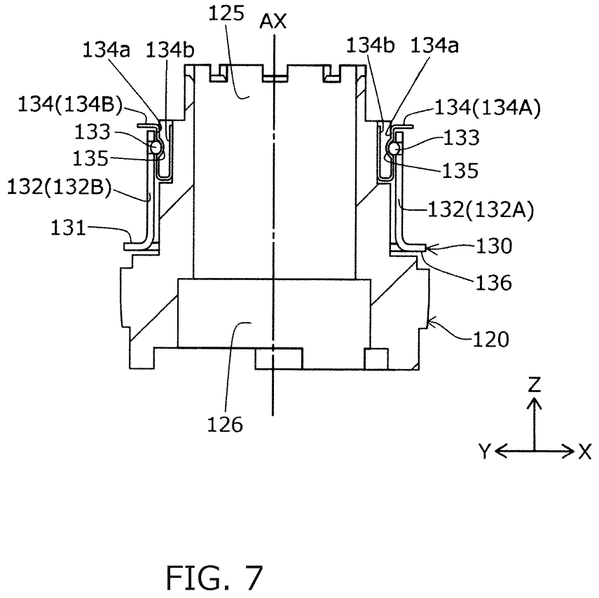

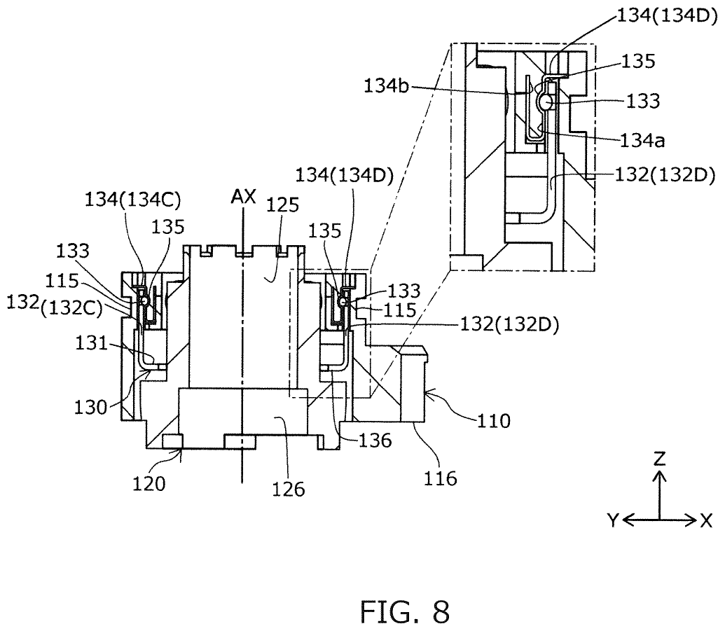

Further, the movable body 120 is, as shown in FIGS. 7 and 8, provided with a first insertion port 125 into which the first connecting portion 32 is capable of being inserted in a first direction (direction from the “+Z” direction side toward the “−Z” direction side) in the optical axis direction, and a second insertion port 126 into which the second connecting portion 42 is capable of being inserted in a second direction (direction from the “−Z” direction side toward the “+Z” direction side) which is an opposite to the first direction. When the movable body 120 connected with the lens unit 3 and the sensor unit 4 is displaced with respect to the fixed body 110, the lens unit 3 and the sensor unit 4 are also displaced with respect to the fixed body 110.

### <Fixed Body>

The fixed body 110 is, as shown in FIGS. 3, 5 and 9, provided with a first opposing face 111 which faces the first face 121, a second opposing face 112 which faces the second face 122, a third opposing face 113 which faces the third face 123, and a fourth opposing face 114 which faces the fourth face 124. As shown in FIGS. 3, 8 and 9, the movable body 120 is disposed in an area surrounded by the first opposing face 111, the second opposing face 112, the third opposing face 113 and the fourth opposing face 114 of the fixed body 110. Further, as shown in FIG. 9, the coil 142A as the coil 142 is provided on the first opposing face 111, the coil 142C as the coil 142 is provided on the second opposing face 112, the coil 142B as the coil 142 is provided on the third opposing face 113, and the coil 142D as the coil 142 is provided on the fourth opposing face 114.

Further, as shown in FIG. 8, the fixed body 110 is provided with a flexible board arrangement groove 115 which is recessed toward an inner side when viewed in the optical axis direction for arranging the flexible board 143 along the fixed body 110. When the flexible board arrangement groove 115 is provided, in a case that the movable body 120 is displaced with respect to the fixed body 110, a situation is suppressed that the flexible board 143 is moved to interfere with the movable body 120.

### <Gimbal Mechanism>

The gimbal mechanism 130 includes, as shown in FIGS. 6 through 9, a turnable member 136 provided with a base plate 131 formed in a frame shape into which the movable body 120 is inserted and four leg parts 132 which are extended from the base plate 131 along the optical axis direction, and support parts 134 each of which is engaged with the leg part 132 and supports the leg part 132 in a turnable state. In this embodiment, as the leg parts 132, the turnable member 136 is, as shown in FIGS. 6 and 7, provided with first leg parts 132A and 132B which are protruded from the base plate 131 to an inner side when viewed in the optical axis direction and then extended along the optical axis direction and, as shown in FIGS. 6 and 8, provided with second leg parts 132C and 132D which are protruded from the base plate 131 to an outer side and then extended along the optical axis direction. Further, as the support parts 134, as shown in FIG. 7, the gimbal mechanism 130 includes first support parts 134A and 134B which are fixed to the movable body 120 and support the first leg parts 132A and 132B in a turnable state and, as shown in FIG. 8, second support parts 134C and 134D which are fixed to the fixed body 110 and support the second leg parts 132C and 132D in a turnable state.

In other words, the support part 134 is provided at two positions in the fixed body 110 on an extension line of a first straight line (“B-B” straight line in FIG. 3) which is extended from a position between the first face 121 and the third face 123 to a position between the second face 122 and the fourth face 124 when viewed in the optical axis direction, and at two positions in the movable body 120 on an extension line of a second straight line (“A-A” straight line in FIG. 3) which is extended from a position between the first face 121 and the fourth face 124 to a position between the second face 122 and the third face 123 when viewed in the optical axis direction. Further, as shown in FIGS. 7 and 8, each of the support parts 134 is similarly structured to each other and is formed in a “U”-shape which is formed of an engaging part 134a, which is formed with a recessed part 135 engaging with the protruded part 133 provided in each leg part 132, and a fixed part 134b which is fixed to the fixed body 110 or the movable body 120, and the engaging part 134a and the fixed part 134b face each other. The gimbal mechanism 130 supports the turnable member 136 by a spring force of the support part 134 in a “U”-shape and turnably holds the movable body 120 with respect to the fixed body 110. In other words, the gimbal mechanism 130 in this embodiment is structured of the turnable member 136 provided with the base plate 131 and the leg parts 132 having high rigidity and the support parts 134 formed in a “U”-shape so as to be easily resiliently bent.

### <Drive Mechanism>

The drive mechanism 140 in this embodiment includes a magnet 141A and a coil 142A provided at a position facing the magnet 141A, a magnet 141B and a coil 142B provided at a position facing the magnet 141B, a magnet 141C and a coil 142C provided at a position facing the magnet 141C, and a magnet 141D and a coil 142D provided at a position facing the magnet 141D. In this embodiment, the magnet 141A, the magnet 141B, the magnet 141C and the magnet 141D are similarly structured to each other, and the coil 142A, the coil 142B, the coil 142C and the coil 142D are similarly structured to each other. In this structure, the magnet 141A and the coil 142A, and the magnet 141C and the coil 142C structure a pitching axis swing mechanism. Further, the magnet 141B and the coil 142B, and the magnet 141D and the coil 142D structure a yawing axis swing mechanism.

Next, the actuator 10 of the optical unit 1 in this embodiment will be described below with reference to FIGS. 9 through 11. The actuator 10 in this embodiment is, as described above, capable of connecting with the lens unit 3 and the sensor unit 4. Further, as described above, the actuator 10 includes the movable body 120 which is connected with the lens unit 3 and the sensor unit 4 and is provided with the first face 121 and the second face 122, which are parallel to the optical axis direction and face each other, and the third face 123 and the fourth face 124 which are parallel to the optical axis direction and perpendicular to the first face 121 and the second face 122 and face each other. Further, the actuator 10 includes the fixed body 110, the gimbal mechanism 130 and the drive mechanism 140 which are described above.

The drive mechanism 140 includes, as shown in FIG. 9, as the magnets 141, a magnet 141A as a first magnet which is disposed on the first face 121, a magnet 141C as a second magnet which is disposed on the second face 122, a magnet 141B as a third magnet which is disposed on the third face 123, and a magnet 141D as a fourth magnet which is disposed on the fourth face 124. Further, the drive mechanism 140 includes, as the coils 142, a coil 142A as a first coil disposed on the first opposing face 111 of the fixed body 110 which is a face facing the first magnet (magnet 141A), a coil 142C as a second coil disposed on the second opposing face 112 of the fixed body 110 which is a face facing the second magnet (magnet 141C), a coil 142B as a third coil which is disposed on the third opposing face 113 of the fixed body 110 which is a face facing the third magnet (magnet 141B), and a coil 142D as a fourth coil disposed on the fourth opposing face 114 of the fixed body 110 which is a face facing the fourth magnet (magnet 141D). In addition, the drive mechanism 140 includes, as the flexible board 143, a flexible board 143A as a first flexible board which connects the first coil (coil 142A) with the third coil (coil 142B), a flexible board 143B as a second flexible board which connects the third coil (coil 142B) with the second coil (coil 142C), and a flexible board 143C as a third flexible board which connects the second coil (coil 142C) with the fourth coil (coil 142D).

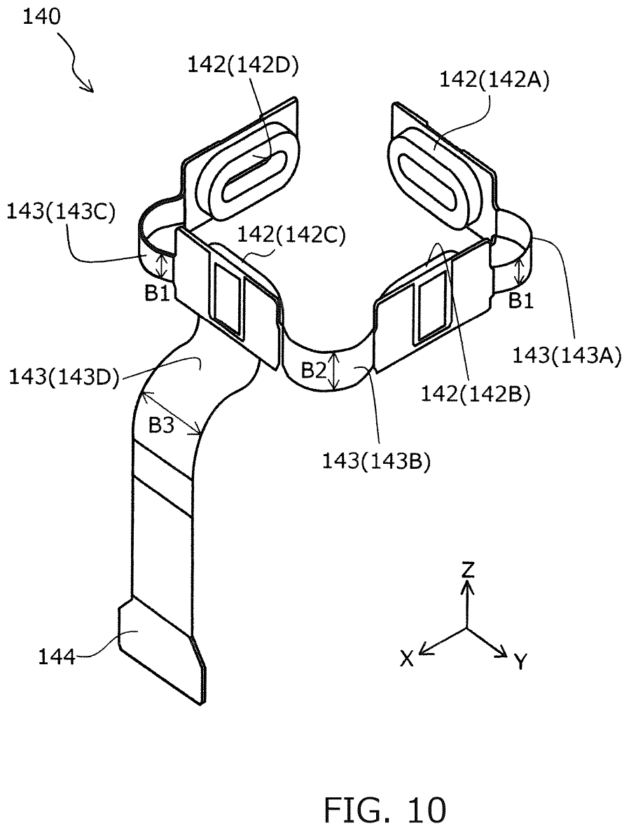

In other words, as shown in FIG. 10, the actuator 10 in this embodiment includes the coil 142A, the coil 142B, the coil 142C and the coil 142D as the drive mechanism 140. In addition, the actuator 10 in this embodiment includes, as the drive mechanism 140, the flexible board 143A which connects the coil 142A with the coil 142B, the flexible board 143B which connects the coil 142B with the coil 142C, the flexible board 143C which connects the coil 142C with the coil 142D, and the flexible board 143D which connects the coil 142C with the terminal 144. In this embodiment, the coil 142A and the coil 142D are not connected with each other, and each of the coil 142A and the coil 142D is the coil 142 located at an end part.

Further, as described above, in the gimbal mechanism 130, the support part 134 is provided at two positions of the fixed body 110 on the extension line of the first straight line (“B-B” straight line in FIG. 3) which is extended from a position between the first face 121 and the third face 123 to a position between the second face 122 and the fourth face 124 when viewed in the optical axis direction, and at two positions of the movable body 120 on the extension line of the second straight line (“A-A” straight line in FIG. 3) which is extended from a position between the first face 121 and the fourth face 124 to a position between the second face 122 and the third face 123 when viewed in the optical axis direction. In other words, in the actuator 10 in this embodiment, an area where the coils 142 are not connected with each other (area where the coil 142A and the coil 142D are not connected with each other) is arranged in the vicinity of the support part 134 which is provided in the movable body 120.

In this embodiment, in a structure that the flexible board 143 which connects the coils 142 with each other is disposed in the vicinity of the support part 134 provided in the movable body 120, in comparison with a structure that the flexible board 143 which connects the coils 142 with each other is disposed in the vicinity of the support part 134 provided in the fixed body 110, the movable body 120 and the flexible board 143 are easily interfered with each other by displacement of the movable body 120. Further, in order to suppress interference of the movable body 120 with the flexible board 143, it is required that a distance between the support part 134 and the flexible board 143 is increased and thickness of a portion of the fixed body 110 in the vicinity of arrangement position of the flexible board 143 (the flexible board arrangement groove 115) is reduced. However, in a case that thickness of a peripheral portion of the fixed body 110 around the arrangement position of the flexible board 143 is reduced, a reinforcing part is required to provide in the fixed body 110 around the arrangement position of the flexible board 143 so as not to reduce rigidity of the fixed body 110 and thus, a size of the actuator 10 is easily increased.

In order to prevent the above-mentioned problem, the actuator 10 in this embodiment is structured so that, in the structure that the support parts 134 which support the leg parts 132 of the gimbal mechanism 130 are formed in the fixed body 110 and the movable body 120, the flexible board 143 which connects the coils 142 structuring the drive mechanism 140 with each other is arranged to separate from a position of the support part 134 provided in the movable body 120 as much as possible. According to this structure, it is not required to reinforce the fixed body 110 in the vicinity of a position of the support part 134 provided in the movable body 120 and thus, a size of the actuator 10 can be reduced.

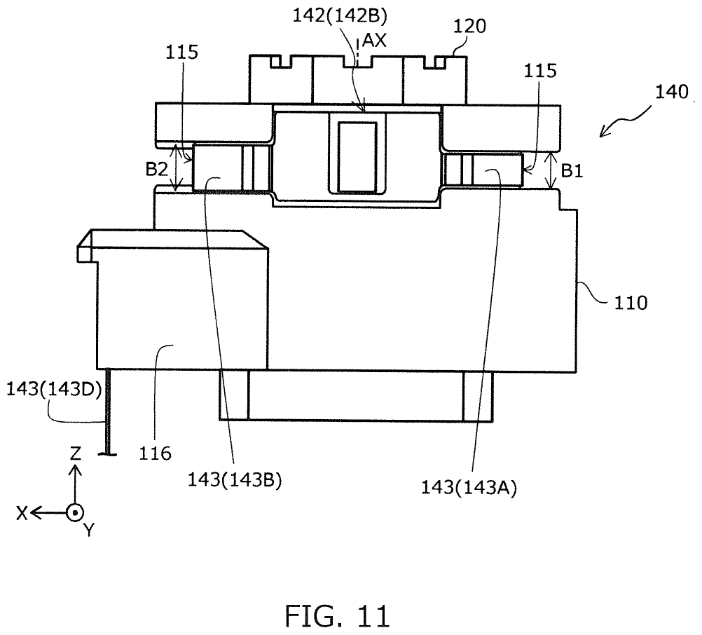

In the actuator 10 in this embodiment, as shown in FIG. 11 and the like, a reinforcing part 116 is formed at a position corresponding to the support part 134 provided in the movable body 120 and in the vicinity of the flexible board arrangement groove 115 of the fixed body 110 where the flexible board 143B is disposed. In other words, in the actuator 10 in this embodiment, when viewed in the optical axis direction, the reinforcing part 116 is formed in the fixed body 110 in the periphery of the second flexible board (flexible board 143B) which connects the third coil (coil 142B) with the second coil (coil 142C). In the actuator 10 in this embodiment, the reinforcing part 116 serves as a fixing part of the flexible board 143D and thus, a decrease in strength of the fixed body 110 at a position in the vicinity of the flexible board arrangement groove 115 where the flexible board 143B is disposed is restrained while suppressing an increase of a size of the actuator 10. In other words, in the actuator 10 in this embodiment, an area where the coils 142 are not connected with each other is arranged at one of positions of two support parts 134 provided in the movable body 120 and thus, the number of the reinforcing parts 116 is reduced and enlargement of the actuator 10 is suppressed.

In this embodiment, as described above, the coil 142A and the coil 142D are not connected with each other, and the coil 142A and the coil 142D are the coils 142 which are respectively located at an end part. Therefore, widths of the flexible board 143A connected with the coil 142A and the flexible board 143C connected with the coil 142D are set to be a narrow width “B1” (width in the optical axis direction) which is necessary for transmission of signal to one coil 142. On the other hand, a width of the flexible board 143B which connects the coil 142B with the coil 142C is set to be a width “B2” (width in the optical axis direction that is two times larger than the width “B1”) which is necessary for transmission of signals to the two coils 142, i.e., the coil 142A and the coil 142B. In this embodiment, a width of the flexible board 143D is set to be a width “B3” (four times larger than the width “B1”) which is necessary for transmission of signals to the four coils 142, i.e., the coil 142A, the coil 142B, the coil 142C and the coil 142D.

As described above, in the actuator 10 in this embodiment, the fixed body 110 is provided with the flexible board arrangement groove 115 which is recessed to an inner side when viewed in the optical axis direction for disposing the flexible board 143 along the flexible board arrangement groove 115. Further, as shown in FIG. 11, a width in the optical axis direction of the flexible board arrangement groove 115 is determined depending on the width “B1” of the first flexible board (flexible board 143A) and the width “B2” of the second flexible board (flexible board 143B) in the optical axis direction. In addition, a width in the optical axis direction of the flexible board arrangement groove 115 corresponding to the third flexible board (flexible board 143C) is also determined depending on the width “B1” of the third flexible board (flexible board 143C). In other words, in the actuator 10 in this embodiment, a width of the flexible board arrangement groove 115 where the flexible board 143 is disposed is set to be narrower as much as possible depending on the flexible board 143 and thus, reduction of the strength in the vicinity of the flexible board arrangement groove 115 is suppressed.

Embodiments of the present invention may be structured as follows.
(1) An actuator capable of connecting with a lens unit and a sensor unit, the actuator including:
a movable body which is connected with the lens unit and the sensor unit and has a first face and a second face, which face each other and are parallel to an optical axis direction, and a third face and a fourth face which face each other and are parallel to the optical axis direction and perpendicular to the first face and the second face,
a fixed body which holds the movable body in a turnable state with at least one of intersecting directions intersecting the optical axis direction as a turning axis,
a gimbal mechanism which includes a turnable member which has a frame-shaped base plate into which the movable body is inserted and a plurality of leg parts which are extended from the base plate along the optical axis direction, and support parts which are engaged with the leg parts and support the leg parts in a turnable state, and
a drive mechanism which has magnets, coils and a flexible board connecting the coils with each other and generates a drive force for turning the movable body with respect to the fixed body. The drive mechanism includes, as the magnets, a first magnet disposed on the first face, a second magnet disposed on the second face, a third magnet disposed on the third face, and a fourth magnet disposed on the fourth face and, as the coils, a first coil disposed on a face of the fixed body facing the first magnet, a second coil disposed on a face of the fixed body facing the second magnet, a third coil disposed on a face of the fixed body facing the third magnet, and a fourth coil disposed on a face of the fixed body facing the fourth magnet and, as the flexible board, a first flexible board connecting the first coil with the third coil, a second flexible board connecting the third coil with the second coil, and a third flexible board connecting the second coil with the fourth coil, and the support part of the gimbal mechanism is provided at two positions in the fixed body on an extension line of a first straight line which is extended from a position between the first face and the third face to a position between the second face and the fourth face when viewed in the optical axis direction and at two positions in the movable body on an extension line of a second straight line which is extended from a position between the first face and the fourth face to a position between the second face and the third face when viewed in the optical axis direction.
(2) In the actuator described in the above-mentioned structure (1), the fixed body is provided with a flexible board arrangement groove which is recessed to an inner side when viewed in the optical axis direction and along which the flexible board is disposed, and a width in the optical axis direction of the flexible board arrangement groove is determined depending on a width of the first flexible board, a width of the second flexible board, and a width of the third flexible board in the optical axis direction.
(3) In the actuator described in the above-mentioned structure (1) or (2), the fixed body is formed with a reinforcing part in a periphery of the second flexible board when viewed in the optical axis direction.
(4) An optical unit including the actuator described in one of the above-mentioned structures (1) through (3), the lens unit, and the sensor unit.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An actuator capable of connecting with a lens unit and a sensor unit, the actuator comprising:
a movable body which is connected with the lens unit and the sensor unit and has a first face and a second face, which face each other and are parallel to an optical axis direction, and a third face and a fourth face which face each other and are parallel to the optical axis direction and perpendicular to the first face and the second face;
a fixed body which holds the movable body in a turnable state with at least one of intersecting directions intersecting the optical axis direction as a turning axis:
a gimbal mechanism which comprises:
a turnable member which has a base plate in a frame shape into which the movable body is inserted, and a plurality of leg parts which are extended from the base plate along the optical axis direction; and
support parts which are engaged with the leg parts and support the leg parts in a turnable state; and
a drive mechanism which comprises magnets, coils and a flexible board connecting the coils with each other and generates a drive force for turning the movable body with respect to the fixed body;
wherein the drive mechanism comprises:
as the magnets, a first magnet disposed on the first face, a second magnet disposed on the second face, a third magnet disposed on the third face, and a fourth magnet disposed on the fourth face;
as the coils, a first coil disposed on a face of the fixed body facing the first magnet, a second coil disposed on a face of the fixed body facing the second magnet, a third coil disposed on a face of the fixed body facing the third magnet, and a fourth coil disposed on a face of the fixed body facing the fourth magnet; and
as the flexible board, a first flexible board connecting the first coil with the third coil, a second flexible board connecting the third coil with the second coil, and a third flexible board connecting the second coil with the fourth coil; and
the support part of the gimbal mechanism is provided at two positions in the fixed body on an extension line of a first straight line which is extended from a position between the first face and the third face to a position between the second face and the fourth face when viewed in the optical axis direction, and at two positions in the movable body on an extension line of a second straight line which is extended from a position between the first face and the fourth face to a position between the second face and the third face when viewed in the optical axis direction.

2. The actuator according to claim 1, wherein
the fixed body comprises a flexible board arrangement groove which is recessed to an inner side when viewed in the optical axis direction and along which the flexible board is disposed, and
a width in the optical axis direction of the flexible board arrangement groove is determined depending on a width of the first flexible board, a width of the second flexible board, and a width of the third flexible board in the optical axis direction.

3. The actuator according to claim 1, wherein the fixed body is formed with a reinforcing part in a periphery of the second flexible board when viewed in the optical axis direction.

4. The actuator according to claim 2, wherein the fixed body is formed with a reinforcing part in a periphery of the second flexible board when viewed in the optical axis direction.

5. An optical unit comprising:
the actuator defined as claim 1;
the lens unit; and
the sensor unit.
